(19) United States
(12) Patent Application Publication
(10) Pub. No.: US 2002/0044300 A1
(43) Pub. Date: Apr. 18, 2002

(54) Multi-function printer and its control method

(76) Inventor: Makoto Oyanagi, Nagano-Ken (JP)

Correspondence Address: MATTINGLY, STANGER & MALUR, P.C., ATTORNEYS AT LAW, 1800 DIAGONAL ROAD, SUITE 370, ALEXANDRIA, VA, 22314, US

(21) Appl. No.: 09/973,914

(22) Filed: Oct. 11, 2001

(30) Foreign Application Priority Data
Oct. 12, 2000 (JP) 2000-311572
Oct. 4, 2001 (JP) 2001-308655

(51) Int. Cl. B41J 1/00; G06F 15/00

(52) U.S. Cl. 358/1.15

(57) ABSTRACT

Even bits of a scan data scanned by a scanner mechanism section (10) are stored in an even interlaced memory (24) and odd bits of the scan data are stored in an odd interlaced memory (26). When an interlaced processing task (42) generates a print image data, the interlaced processing task (42) needs only to read out the even bits of the scan data from the even interlaced memory (24) and read out the odd bits of the scan data from the odd interlaced memory (26), so that a waiting time for a high definition printing becomes as short as possible.

### BACKGROUND OF THE INVENTION

1. Field of the Invention

The present invention relates generally to a multi-function printer and its control method. More specifically, the invention relates to a multi-function printer capable of a reduction of a printing time for a copy print, and its control method.

2. Description of the Related Art

A multi-function printer, which is a combination of a scanner and a printer and they are built in one housing, becomes widespread. In such a multi-function printer, it is possible to accomplish a function as the scanner, a function as the printer and a function as a copy machine by one device. In this case, a so-called page printer is used as the printer portion. However, it is possible to downsize the device and reduce a price thereof in a case where a serial printer like a so-called color ink jet printer and so on is used as the printer portion.

By the way, when this multi-function printer is used as the copy machine, a scan data obtained by a scan operation in the scanner is temporarily stored, and a print image data is generated on the basis of the stored scan data. Then, the print image data is transferred to a printer engine and a printing operation is performed to printing paper.

However, when the serial printer like the ink jet printer is used as the printer, an arrangement of the scan data scanned in by the scan operation of the scanner is different from an arrangement of the print image data in some cases based on a combination of an operation of a carriage on which a print head is mounted and a paper feed operation. A typical example thereof is an interlaced processing.

FIG. 12 is a diagram for explaining a concept of the interlaced processing. In an example of FIG. 12, a print head of the ink jet printer has forty-eight ink jet nozzles, therefore printing for forty-eight lines can be realized by one print pass of the print head. Furthermore, in this example, printing for one raster can be realized by two passes of the print head. That is, printing for odd lines composed of #1, #3, . . . #95 is performed by a first pass of the print head, and printing for even lines composed of #2, #4, . . . #96 is performed by a second pass of the print head.

In the example of FIG. 12, after the first pass of the print head is ended, the print paper is fed by one line and then the second pass of the print head is started. However, after the first pass of the print head is ended, the print paper is fed by twenty-four lines (½ raster) and then the second pass of the print head is started in some printers.

Furthermore, another typical example in which the arrangements of the scan data and the print image data are different is a thinning-out print. In this thinning-out print, dots of one line of the scan data is thinned out at predetermined intervals to execute high definition printing operation. In this high definition printing operation, for example, the print head twice moves to print one line of the scan data.

FIG. 13 is a diagram for explaining a processing concept in which the print head twice moves to print one line of the scan data. FIG. 13 only shows line #1, but lines #2 thorough #96 other than the line #1 are the same as line #1.

First, even dots of the scan data are printed by one print pass of the print head in a first time. Subsequently, odd dots of the scan data are printed by one print pass of the print head in a second time. In printing of the second pass of the print head, the odd dots are printed so as to be located between the even dots printed by the first pass of the print head.

However, there is a problem that a carriage on which the print head is mounted stops every carriage movement because it takes much time to generate the print image data on the basis of the scan data. For example, in a case where a processing of classifying the scan data into the even dots and the odd dots is executed in a software operation, it takes much time to execute it, so that there is a problem that the carriage on which the print head is mounted stops every carriage movement. In other words, since the carriage movement stops every print pass, there is a problem that it is impossible to make the carriage move continuously in a rightward and leftward main scan pass direction. As a result of this, a performance is lowered when the scan data scanned in by the scanner is printed. If processing ability of a CPU is not enough, this problem arises as conspicuous problem in especial.

### SUMMARY OF THE INVENTION

It is therefore an object of the present invention to eliminate the aforementioned problems and to speed up its printing speed in the multi-function printer which executes a printing operation for a scan data scanned in by the scanner by using a print image data with a different data arrangement.

In order to accomplish the aforementioned and other objects, according to one aspect of the present invention, a multi-function printer which is a combination of a scanner and a printer, comprising:

a first data storage in which a scan data scanned in by the scanner is stored;

a print executer which generates a print image data having a data format suitable for a print processing on the basis of the scan data stored in the first data storage and performs printing by a print pass driving a print head of the printer with the print head moved on the basis of the print image data; and

a data classifier which classifies the scan data in a format suitable for generating the print image data and stores it in the first data storage.

According to another aspect of the present invention, a multi-function printer which is a combination of a scanner and a printer and capable of printing one line of a scan data, which is scanned in by the scanner, in the printer by movements of a printhead in a main scan pass direction by X times, comprising:

a classificational storing section which classifies the scan data according to an appropriate data format for each time of the X times of the movement of the print head in the main scan pass direction and which stores them in a first data storage;

a print image data generator which sequentially reads out the classified scan data from the first data storage and generates a print image data-on the basis of the read-out scan data every reading out; and

a print executer which executes printing with the print head moved in the main scan pass direction on the basis of the print image data generated by the print image data generator.

According to a further aspect of the present invention, a control method for a multi-function printer, which is a combination of a scanner and a printer, comprising the steps of:

classifying a scan data scanned in by the scanner according to an appreciate format for generating a print image data in actual printing;

storing the classified scan data in a first data storage under classified conditions;

generating the print image data, which has a data format appropriate for a print processing, on the basis of the scan data stored in the first data storage; and

performing the print processing by a print pass with a print head of the printer moved on the basis of the print image data.

According to a still further aspect of the present invention, a control method for a multi-function printer which is a combination of a scanner and a printer and capable of printing one line of a scan data, which is scanned by the scanner, in the printer by movements of a print head in a main scan pass direction by X times, comprising the steps of:

classifying the scan data according to an appropriate data format for each of the X times of the movement of the print head in the main scan pass direction;

storing the classified scan data in a first data storage;

reading out the classified scan data sequentially from the first data storage to generates a print image data on the basis of the scan data every reading out; and

executing printing with the print head moved in the main scan pass direction on the basis of the generated print image data.

### BRIEF DESCRIPTION OF THE DRAWINGS

FIG. 1 is a block diagram showing an internal structure of a multi-function printer according to one embodiment of the present invention;

FIG. 2 is a block diagram explaining various tasks provided in the multi-function printer of FIG. 1;

FIG. 3 is a flow chart explaining contents of a scanner processing (scanner processing task) according to the embodiment;

FIG. 4 is a flow chart explaining contents of a classificational processing executed in a scanner ASIC according to the embodiment;

FIG. 5 is a diagram showing one example of a hardware structure to realize the classificational processing shown in FIG. 4;

FIG. 6 is flow chart explaining contents of an interlaced development processing (interlaced processing task) according to the embodiment;

FIG. 7 is a diagram explaining a processing for generating a print image data which has been subjected to the interlaced processing with using a even interlaced memory and a odd interlaced memory;

FIG. 8 is a flow chart explaining contents of print execution processing (print execution processing task) according to the embodiment;

FIG. 9 is a flow chart explaining contents of a classificational processing executed in a scanner ASIC according to a second embodiment of the present invention;

FIG. 10 is a diagram showing one example of a structure of an even look up table which is used by the classification processing shown in FIG. 9;

FIG. 11 is a diagram showing one example of a structure of an odd look up table which is used by the classification processing shown in FIG. 9

FIG. 12 is a diagram explaining a processing concept of an interlaced processing;

FIG. 13 is a diagram explaining a print operation in which even dots and odd dots are printed by two print passes for a high definition printing;

FIG. 14 is a schematic diagram explaining a method of a high definition printing operation according to a third embodiment of the present invention;

FIG. 15 is a flowchart explaining contents of an interlaced development processing (interlaced processing task) according to the third embodiment;

FIG. 16 is a diagram explaining a structure of the scan data formed in an even interlaced memory according to the third embodiment;

FIG. 17 is a diagram explaining a structure of the scan data formed in an odd interlaced memory according to the third embodiment; and

FIG. 18 is a diagram explaining one modified example for the third embodiment of the present invention.

### DESCRIPTION OF THE PREFERRED EMBODIMENTS

[First Embodiment]

According to a first embodiment of the present invention, an ASIC classifies a scan data into even dots and odd dots which are previously divided and stored in a interlaced memory, whereby when an interlaced processing is executed as a software processing, a print image data can be generated without a classifying processing. Thereby, the scan data scanned in by a scanner can be printed as short time as possible. More detailed explanation will be given hereinafter.

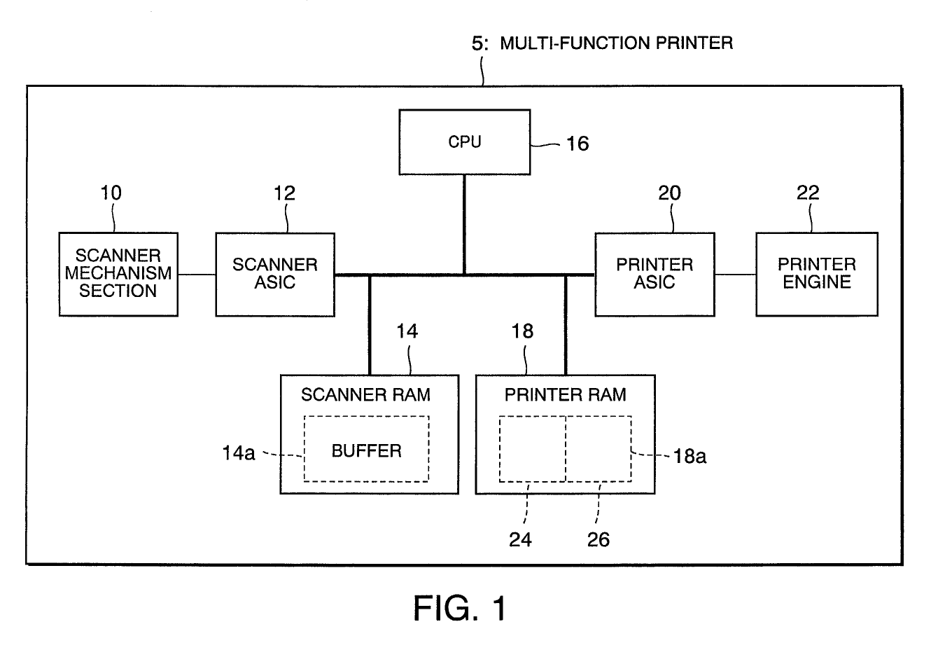

First, in accordance with FIG. 1, an internal structure of a multi-function printer 5 according to this embodiment will be explained. FIG. 1 is a diagram showing the internal structure of the multi-function printer 5 which is a combination of a scanner and a printer.

As shown in FIG. 1, the multi-function printer 5 has a scanning mechanism section 10, a scanner ASIC (Application Specific IC) 12, a scanner RAM (Random Access Memory) 14, a CPU (Central Processing Unit) 16, a printer RAM 18, a printer ASIC 20 and a printer engine 22.

The scanner ASIC 12, the scanner RAM 14, the CPU 16, the printer RAM 18 and the printer ASIC 20 are connected one another via an internal bus. A buffer 14a, in which a scan data scanned in by the scanning mechanism section 10 is temporarily stored, is formed in the scanner RAM 14, and a interlaced memory 18a, in which the scan data is stored until it is subjected to an interlaced processing, is formed in the printer RAM 18. The scanner RAM 14 and the printer RAM 18 are separately provided in this embodiment, but they may be unified into one RAM.

Furthermore, in this embodiment, the interlaced memory 18a is divided into an even interlaced memory 24 and an odd interlaced memory 26. The even interlaced memory 24 stores even bits of the scan data, and the odd interlaced memory 26 stores odd bits of the scan data. A processing of classifying the scan data into the even bits and the odd bits is executed in the scanner ASIC 12.

The scanning mechanism section 10 has a line image sensor to scan a document optically. The line image sensor is mounted on a carriage and the carriage moves from one end side to the other end side of the document, so that the whole document can be scanned in. This scanning operation is controlled by the scanner ASIC 12, and the scanned-in scan data is stored in the buffer 14a formed in the scanner RAM 14. In a high definition printing operation, at time when a predetermined amount of the scan data is accumulated in the buffer 14a, the scan data is classified into the even bits and the odd bits and they are transferred to the even interlaced memory 24 and the odd interlaced memory 26 formed in the printer RAM 18, respectively.

The scan data stored in the even interlaced memory 24 and the odd interlaced memory 26 is subjected to the interlaced processing in the CPU 16, and then it is transmitted to the printer ASIC 20 as a print image data. In this embodiment, the scan data stored in the even interlaced memory 24 is subjected to the interlaced processing to generate the print image data at first, and then it is transmitted to the printer ASIC 20 as the print image data for one print pass. For example, on the basis of the scan data in odd lines of the even interlaced memory 24, the print image data for one print pass is generated to transmit it to the printer ASIC 20. The printer ASIC 20 controls the printer engine 22 on the basis of the print image data for one print pass and executes the printing operation. Specifically, ink is spouted from a plurality of ink jet nozzles in the print head while it makes the print head move in a main scan pass direction, so that the even dots are printed on the printing paper.

Next, the CPU 16 executes the interlaced processing to the scan data stored in the odd interlaced memory 26 and then it is transmitted to the printer ASIC 20 as the print image data for the print pass which is located in the same line as the former print pass. For example, on the basis of the scan data in odd lines of the odd interlaced memory 26, the print image data for one print pass is generated to transmit it to the printer ASIC 20. The printer ASIC 20 controls the printer engine 22 on the basis of the print image data and executes the printing operation. In this operation, printing is performed so that the odd dots printed in this time are located between the even dots previously printed on the printing paper.

Next, the multi-function printer 5 of this embodiment feeds the printing paper in a sub-scan pass direction (it is a direction crossing the main scan pass direction) by one line. Then, in the same manner, the scan data stored in even lines of the even interlaced memory 24 is printed and the scan data stored in even lines of the odd interlaced memory 26 is printed. In this way, the printing operations of moving the print head in the main scan pass direction are executed four times, so that printing for one raster can be performed.

In this embodiment, after the scan data in one line is classified into the even dots and the odd dots, the printing operation of even dots and the printing operation of odd dots are separately performed and the printing operation of odd lines and the printing operation of even lines is also separately performed in this way, so that the high definition print is realized.

As is evident from the above-description, the multi-function printer 5 according to this embodiment does not have a memory buffer as a unit of a page, but it performs the print operation with the scanned-in scan data stored in the printer RAM 18 by unit of at least one band (one band is equal to a height of the print head).

Although an outline of the processing contents of the multi-function printer 5 has been described above, various tasks which the multi-function printer 5 includes will be explained hereinafter.

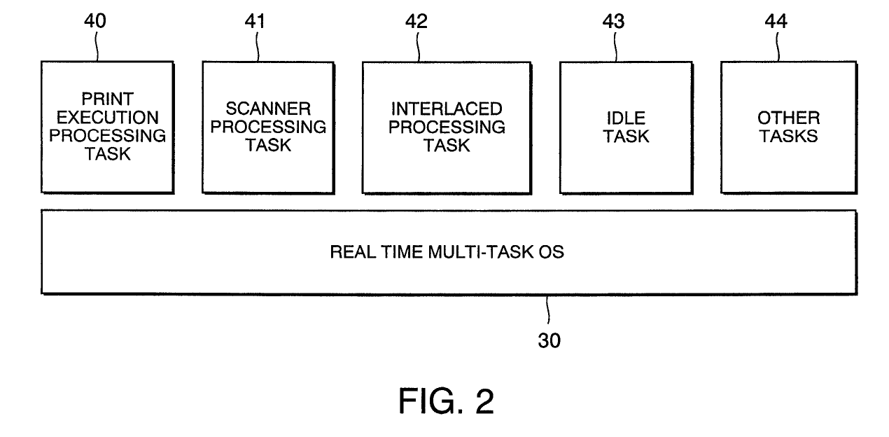

FIG. 2 is a diagram showing the various tasks executed in the CPU 16. In this embodiment, the multi-function printer 5 has only one CPU 16 as a central processing unit. Therefore, the CPU 16 executes both a task processing concerning the scanner and a task processing concerning the printer. Furthermore, a real time multi-task OS (operating system) 30 is adapted in the multi-function printer 5 according to this embodiment. Therefore, the CPU 16 is assigned for the various tasks with predetermined priorities by the real time multi-task OS 30.

As shown in FIG. 2, the multi-function printer 5 has a print execution processing task 40, a scanner processing task 41, an interlaced processing task 42 and an idle task 43. In addition to these tasks, it has various tasks as other tasks 44.

Although specific processing contents of each task will be explained later, in short, the scanner processing task 41 is a task for executing the scan processing mentioned above. The interlaced processing task 42 is a task for reading out the scan data from the even interlaced memory 24 and the odd interlaced memory 26 and executing the interlaced processing. The print execution processing task 40 is a task for executing a print on the basis of the print image data which has been subjected to the interlaced processing.

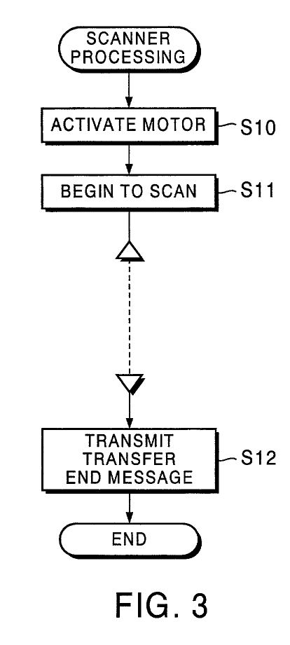

FIG. 3 is a diagram showing a flow chart for explaining contents of a scanner processing, which is executed in the scanner processing task 41 according to this embodiment. The scanner processing shown in FIG. 3 is a process which starts on the basis of a transfer request transmitted from the interlaced processing task 42. That is, the transfer request is a trigger to activate the scanner processing task 41. The number of lines that the scan data is requested is specified in this transfer request. For example, it includes a specification that the scan data of ten lines is needed.

As shown in FIG. 3, the scanner processing task 41 activates a motor for driving the carriage in the scanner mechanism section 10 (Step S10). Then, it instructs the scanner ASIC 12 to begin a scan operation (Step S11). A concrete control of the scan operation is performed in the scanner ASIC 12. As a result, the scanner processing task 41 releases the CPU 16 after instructing the scanner ASIC 12 to begin the scan operation.

The scanner ASIC 12 executes the scan operation by the specified number of lines and then stores the scanned-in scan data in the buffer 14a. For example, in a case where the scan instruction of ten lines has been received, the scanner ASIC 12 stores the scan data of ten lines in the buffer 14a.

Subsequently, the scanner ASIC 12 classifies the scan data stored in the buffer 14a into even bits and odd bits to transfer the even bits of the scan data to the even interlaced memory 24 and transfer the odd bits of the scan data to the odd interlaced memory 26. Then, when the transfer of all the scan data stored in the buffer 14a is ended, the scanner ASIC 12 generates an interrupt of a scan end.

On the basis of the interrupt of the scan end, the scanner processing task 41 is activated again. Then, as shown in FIG. 3, the scanner processing task 41 transmits a transfer end message, which means that the transfer operation is completed, to the interlaced processing task 42 (Step S12). As a result, the scanner processing is ended.

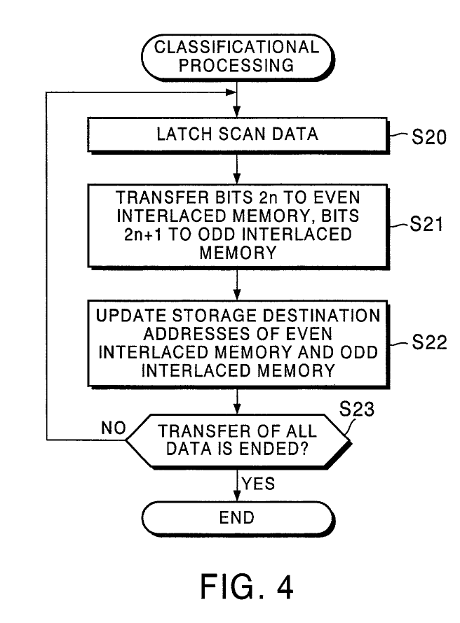

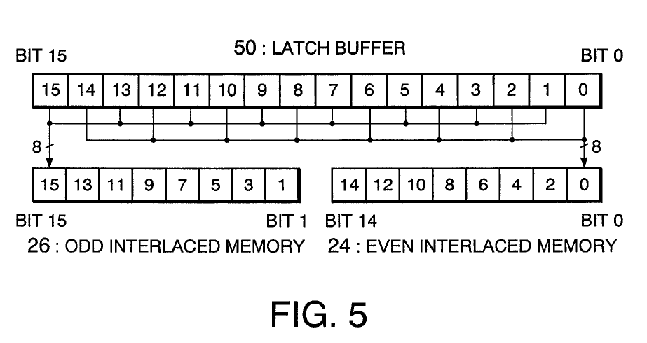

Next, on the basis of FIG. 4 and FIG. 5, the above-mentioned classificational processing, which is executed in the scanner ASIC 12, for the scan data will be explained in detail. FIG. 4 is a flow chart for explaining contents of the classificational processing which is executed in the scanner ASIC 12. FIG. 5 is a diagram showing one example of a hardware structure provided in the scanner ASIC 12 to realize the classificational processing.

As shown in FIGS. 4 and 5, when a predetermined amount of the scan data is stored in the buffer 14a, the scanner ASIC 12 latches the scan data from the buffer 14a and stores it in a latch buffer 50 (Step 20). In this embodiment, this latch processing is in units of 16 bits (units of one word). However, a data length for the latch processing may be in units of 8 bits (units of one byte) or in units of 32 bits (units of one long word) or the like.

Next, bits 2n (n=0 through 7) of the scan data are transferred to the even interlaced memory 24, and bits 2n+1 (n=0 through 7) of the scan data are transferred to the odd interlaced memory 26 (Step 21). As a result, the scan data of the bits 0, 2, 4, 6, 8, 10, 12 and 14 are stored in the even interlaced memory 24, and bits 1, 3, 5, 7, 9, 11, 13 and 15 are stored in the odd interlaced memory 26.

Next, both a storage destination address of the even interlaced memory 24 and a storage destination address of the odd interlaced memory 26 are updated (Step S22). By updating these storage destination addresses, addresses to which the next scan data is stored are fixed.

Next, it is judged whether all the scan data stored in the buffer 14a has been transferred to the even interlaced memory 24 and the odd interlaced memory 26 (Step S23). If all the scan data has been transferred (Step S23: Yes), this classificational processing is ended. As described above, the scanner ASIC 12 generates the interrupt of the scan end in this case. On the other hand, if all the scan data has not been transferred yet (Step S23: No), the processes from the step 20 mentioned above are repeated.

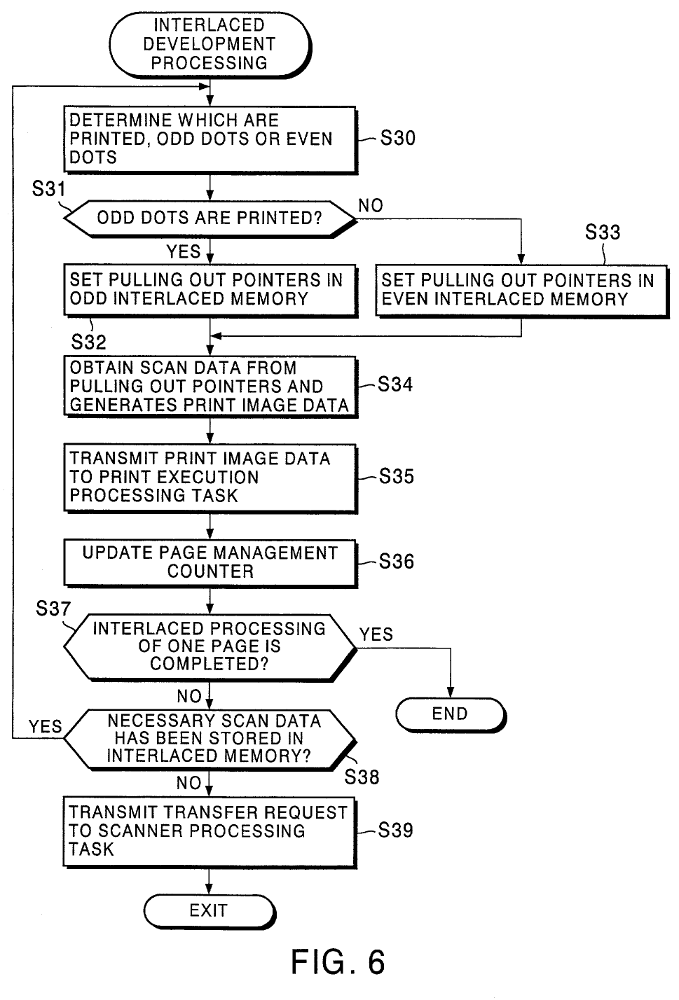

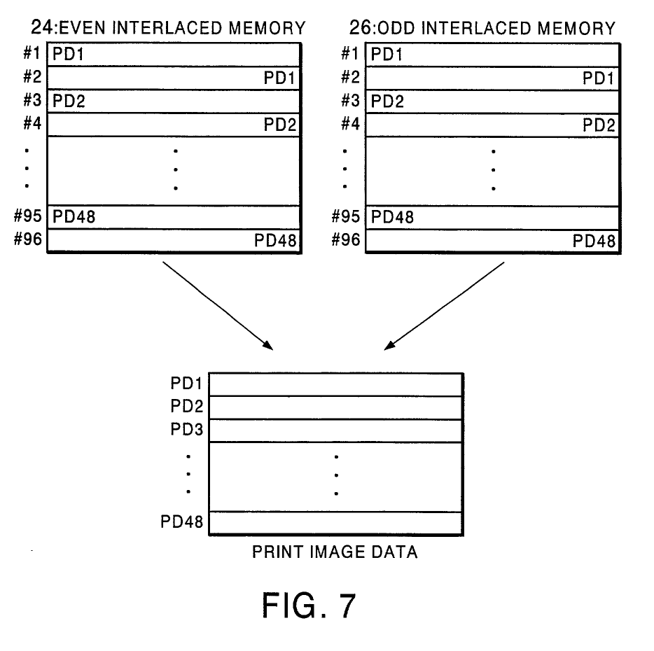

Next, on the basis of FIG. 6 and FIG. 7, processing contents of the interlaced processing task 42 will be explained. This FIG. 6 is a diagram showing a flow chart for explaining contents of the interlaced development processing which is executed in the interlaced processing task 42 according to this embodiment. This interlaced development processing shown in FIG. 6 is a process activated by the transfer end message transmitted from the scanner processing task 41. That is, the transfer end message is a trigger to activate the interlaced processing task 42. FIG. 7 is a diagram for explaining a process of a generating processing of the print image data on the basis of the scan data stored in the even interlaced memory 24 and the odd interlaced memory 26.

As shown in FIG. 6, first, in the interlaced processing task 42 according to this embodiment, it is determined whether odd dots are printed in the next pass or even dots are printed in the next pass (Step S30). Subsequently, the interlaced processing task 42 judges whether it has been determined to print the odd bots in the next pass or not (Step S31). If it has been determined to print the odd dots (Step S31: Yes), pulling out pointers are set in the odd interlaced memory 26 (Step S32).

In one example of FIG. 7, when odd lines #1, #3, . . . #95 stored in the odd interlaced memory 26 are printed, the pulling out pointers are set at the odd lines #1, #3, . . . #95 of the odd interlaced memory 26. That is, the print head of the multi-function printer 5 according to this embodiment has ink spouting nozzles of forty-eight.

On the other hand, as shown in FIG. 6, it has been judged to print the even dots in Step S31 (Step S31: No), the pulling out pointers are set in the even interlaced memory 24 (Step S33).

In one example of FIG. 7, when odd lines #1, #3, . . . #95 stored in the even interlaced memory 24 are printed, the pulling out pointers are set at the odd lines #1, #3, . . . #95 of the even interlaced memory 24.

Next, as shown in FIG. 6, the interlaced processing task 42 obtains the scan data at the pulling out pointers and then generates the print image data (Step S34). In this embodiment, as shown in FIG. 7, the print image data of one print pass is generated on the basis of forty-eight lines composed of PD1 through PD48. These PD1 through PD48 correspond to the ink spouting nozzles 1 through 48 of the print head, respectively.

Next, as shown in FIG. 6, the interlaced processing task 42 transmits the generated print image data to the print execution processing task 40 (Step S35). As a result, the printing operation in which the print head moves once in the main scan pass direction is performed. Subsequently, a page management counter is updated (Step S36). This page management counter is a counter to judge whether the print image data of one page has been generated or not.

Subsequently, the interlaced processing task 42 judges whether or not the interlaced processing of one page is completed based on the page management counter (Step S37). If the interlaced processing of one page is completed (Step S37: Yes), the interlaced development processing is ended.

On the other hand, if the interlaced processing of one page is not completed yet (Step S37: No), it judges whether or not the scan data necessary to execute the next interlaced processing is stored in the interlaced memory 18a (Step S38).

If it has judged that the scan data necessary to execute the next interlaced processing has been stored in the interlaced memory 18a (Step S38, Yes), the processes from the step S30 are repeated.

On the other hand, if it has judged that the scan data necessary to executes the next interlaced processing has not been stored in the interlaced memory 18a (Step S38: No), the next transfer request is transmitted to the scanner processing task 41 (Step S39). Then, the interlaced processing task 42 is stopped for the present. In this case, by transmitting the above-mentioned transfer end message from the scanner processing task 41, this interlaced processing task 41 is activated again.

As is apparent from FIGS. 6 and 7, the printing operation of the scan data for one raster needs to move the print head four times in the main scan pass direction. For example, the odd lines in the even interlaced memory 24 are printed at a first moving of the print head, the odd lines in the odd interlaced memory 26 are printed at a second moving of the print head, the even lines in the even interlaced memory 24 are printed at a third moving of the print head, and the even lines in the even interlaced memory 26 are printed at a fourth moving of the print head.

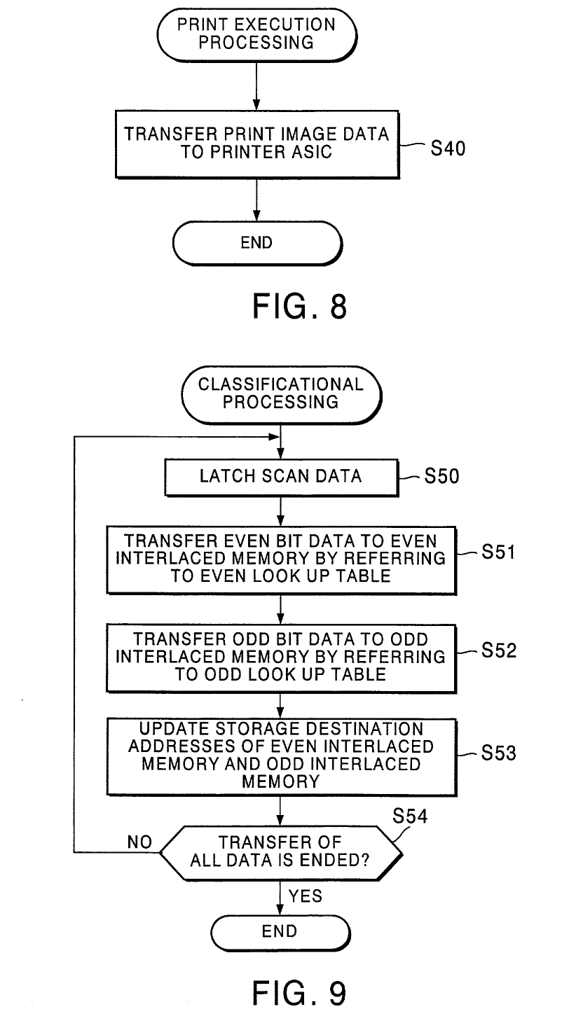

Next, on the basis of FIG. 8, processing contents of the print execution processing task 40 will be explained. FIG. 8 is a diagram showing a flow chart for explaining the contents of the print execution processing executed in the print execution processing task 40 according to the embodiment. The print execution processing shown in FIG. 8 is a process which is activated by a print request containing the print image data, which is transmitted from the interlaced processing task 42. That is, the print request is a trigger to activate the print execution processing task 40.

As shown in FIG. 8, the print execution processing task 40 according to this embodiment transfers the print image data received with the print request to the printer ASIC 20 (Step S40). In this embodiment, control of the actual printing operation for the printing paper by the printer engine based on the print image data is executed in the printer ASIC 20. Therefore, by transferring the print image data to the printer ASIC 20, the print execution processing task 40 is ended. The printer ASIC 20 controls the printer engine 22 on the basis of the print image data and then moves the print head once in the main scan pass direction to perform printing of one print pass.

As described above, according to multi-function printer 5 of this embodiment, since the scan data has been divided into the even bits and the odds bits and they have been stored in the even interlaced memory 24 and the odd interlaced memory 26 respectively, it is unnecessary to classify the scan data into the even bits and the odd bits in the interlaced processing task 42. Therefore, even though it is a high definition printing operation, it is possible to execute the printing operation by the maximum throughput of the printer engine 22. That is, it is possible that the main scan pass operation of the carriage mounted with the print head of the printer does not stop to print the scan data which is read in by the scanner mechanism section 10.

Furthermore, in this embodiment, the processing in which the scan data is classified into the even data and the odd data is executed in the scanner ASIC 12, i.e. a hardware, so that the classificational processing can be performed at high speed even though the multi-function printer 5 has only one CPU 16. The printing time shorter than before can be realized even though the processing speed of the CPU 16 is not enough.

[Second Embodiment]

The classificational processing executed in the scanner ASIC 12 according to the above-mentioned first embodiment is modified in a second embodiment.

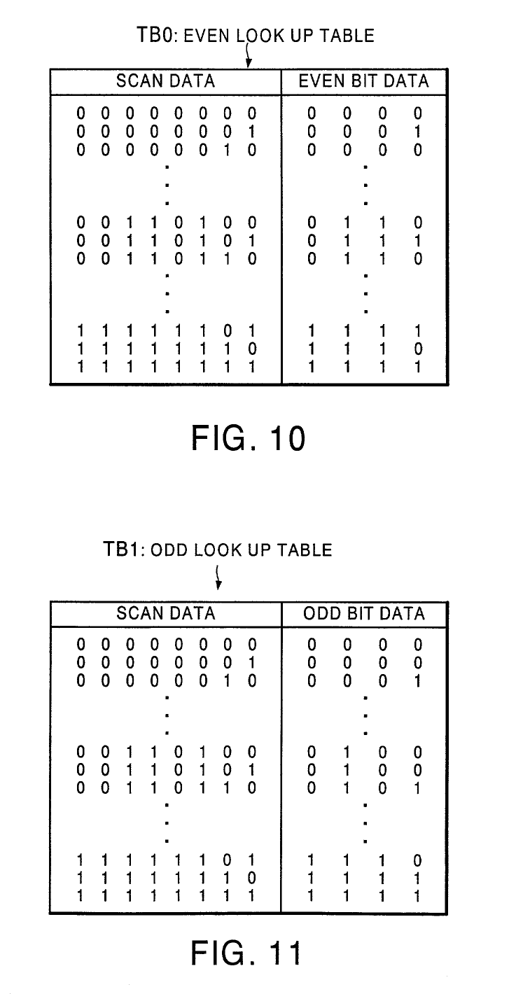

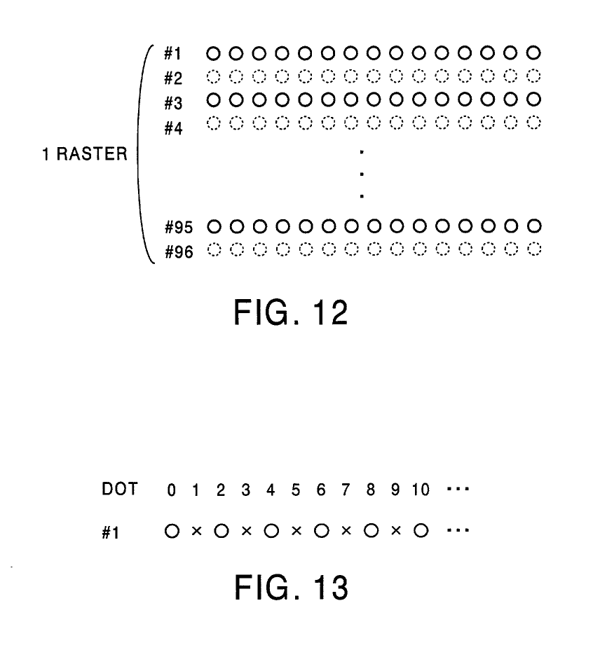

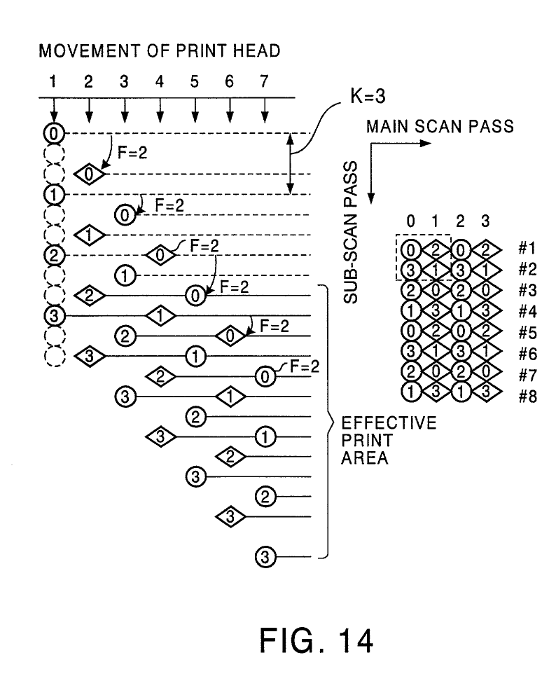

FIG. 9 is a flow chart for explaining contents of a classificational processing according to this embodiment. FIG. 10 and FIG. 11 are diagrams for showing an even look up table TB0 and an odd look up table TB1 respectively and they both are used in the classificational processing of FIG. 9.

First, on the basis of FIG. 10 and FIG. 11, construction of the even look up table TB0 and the odd look up table TB1 will be explained. As shown in FIG. 10, the even look up table TB1 contains a plurality of 4-bit even bit data, which correspond to all patterns of 8-bit of the scan data. That is, the 4-bit data, each of which is obtained to extract the even bits from the 8-bit scan data, are stored for all the 256 patterns which can be generated from the 8-bit scan data. Then, when 8-bit of the scan data is obtained, the even bits data can be obtained by retrieving the even look up table TB0. This is the same as the odd look up table TB1 shown in FIG. 11. In this embodiment, the even look up table TB0 and the odd look up table TB1 are formed in the scanner ASIC 12.

Next, the classificational processing executed in the scanner ASIC 12 will be explained on the basis of FIG. 9. As shown in FIG. 9, when a predetermined amount of the scan data is stored in the buffer 14a, the scanner ASIC 12 latches the scan data and stores it in the latch buffer 50 (Step S50). In this embodiment, this latch processing is in units of 8 bits (units of one byte). However, the data length of the latch processing may be in units of 16 bits (units of one word) or in units of 32 bits (units of one long word) or the like. In these cases, it is necessary to form the even look up table TB0 and the odd look up table TB1 for 16-bit or 8-bit in compliance with the length of the latched data.

Next, the even bits data which corresponds to even bits of the scan data latched in Step S50 is obtained by referring to the even look up table TB0, and the even bits data is transferred to the even interlaced memory 24 (Step S51). That is, the even bits data, which is composed of even bits extracted from the 8-bit scan data, is obtained by referring to the even look up table TB0 shown in FIG. 10. For example, in a case where “00110100” data is latched as a scan data in Step S50, “0110” data is obtained as an even bits data on the basis of the even look up table TB0. And then, the even bits data is transferred to the even interlaced memory 24.

Similarly, as shown in FIG. 9, the odd bits data which corresponds to odd bits of the scan data latched in Step S50 is obtained by referring to the odd look up table TB1, and the odd bits data is transferred to the odd interlaced memory 26 (Step S52). That is, the odd bits data, which is composed of odd bits extracted from the 8-bit scan data, is obtained by referring to the odd look up table TB1 shown in FIG. 11. For example, in the same manner as the above-mentioned, in a case where “00110100” data is latched as a scan data in Step S50, “0100” data is obtained as an odd bits data on the basis of the odd look up table TB1. And then, the odd bits data is transferred to the odd interlaced memory 26.

Next, the storage destination address of the even interlaced memory 24 and the storage destination address of the odd interlaced memory 26 are updated respectively (Step 53). By updating the storage destination addresses, addresses to which the next scan data is stored are fixed.

Next, it is judged whether all the scan data stored in the buffer 14a has been transferred to the even interlaced memory 24 and the odd interlaced memory 26 (Step S54). If all the scan data has been transferred (Step S54: Yes), this classificational processing is ended. On the other hand, if all the scan data has not been transferred yet (Step S54: No), the processes from the step 50 mentioned above are repeated.

As described above, according to multi-function printer 5 of also this embodiment, in the same manner as the above-mentioned first embodiment, since the scan data has been divided into the even bits and the odds bits and they have been stored in the even interlaced memory 24 and the odd interlaced memory 26 respectively, it is unnecessary to classify the scan data into the even bits and the odd bits in the interlaced processing task 42. Therefore, even though it is a high definition printing operation, it is possible to execute the printing operation by the maximum throughput of the printer engine 22. That is, it is possible that the main scan pass operation of the carriage mounted with the print head of the printer does not stop to print the scan data which is read in by the scanner mechanism section 10.

Furthermore, in this embodiment as well, the processing in which the scan data is classified into the even data and the odd data is executed in the scanner ASIC 12, i.e. a hardware, so that the classificational processing can be performed at high speed even though the multi-function printer 5 has only one CPU 16. The printing time shorter than before can be realized even though the processing speed of the CPU 16 is not enough.

[Third Embodiment]

Method of the interlaced processing of the above-mentioned first and second embodiment is modified in a third embodiment of the invention.

FIG. 14 is a diagram for explaining a method of a high definition printing according to this embodiment. As shown in FIG. 14, in this embodiment, one line of the scan data which is read in by the scanning mechanism section 10 is printed to be separated into even dots and odd dots, and interlaced processing task 42 performs the interlaced processing of three lines. Furthermore, after the print head once moves in the main scan pass direction, the printing paper is fed by two lines in the sub-scan pass direction, so that neighboring four dots in the rectangular form on the printing paper which have been printed are printed by different ink jet nozzles.

Specifically, in the example of FIG. 14, the print head has four ink jet nozzles of No. 1 through No. 4. In addition, in FIG. 14, the even dots are expressed in circled marks and the odd dots are expressed in rectangular marks.

By movement of the printhead in the main scan pass direction in a first time, the even dots in line #2 are printed by the No. 3 nozzle, and then the paper feed operation of two lines is performed. By movement of the print head in the main scan pass direction in a second time, the odd dots in lines #1 and #4 are printed by No. 2 and No. 3 nozzles respectively, and then the paper feed operation of two lines is performed. By movement of the print head in the main scan pass direction in a third time, the even dots in lines #3 and #6 are printed by No. 2 and No. 3 nozzles respectively, and then the paper feed operation of two lines is performed. By movement of the print head in the main scan pass direction in a fourth time, the odd dots in lines #2, #5 and #8 are printed by No. 1, No. 2 and No. 3 nozzles respectively, and then the paper feed operation of two lines is performed. By movement of the print head in the main scan pass direction in a fifth time, the even dots in lines #1, #4, #7 and #10 are printed by No. 0 through No. 3 nozzles respectively, and then the paper feed operation of two lines is performed.

After that, in the same manner as this, the processes of alternate printing of the even dots and the odd dots are repeated every three lines to print the scan data. However, as shown in FIG. 14, its effective print area printed on the printing paper correctly is on and under the ninth line from the line of the No. 0 nozzles in the first movement of the print head, in the sub-scan pass direction.

In addition, relationship between K and F is prime to each other, where K is an interval of the lines extracted from the scan data to be printed (K=3, in the example of FIG. 14) and F is the number of lines of the paper feed operation (F=2, in the example of FIG. 14). This relationship is kept, so that the neighboring four dots in the rectangular form are printed by the different ink jet nozzles as shown by a doted line in FIG. 14.

The hardware construction of the multi-function printer 5 according to this embodiment is the same as that of FIG. 1. In addition, it is the same as the first embodiment and the second embodiment mentioned above that the scan data is classified into the even bits and the odd bits in the scanner ASIC 12 and they are stored in the even interlaced memory 24 and the odd interlaced memory 26 respectively. However, contents of the interlaced processing task 42 executed in the CPU 16 are different.

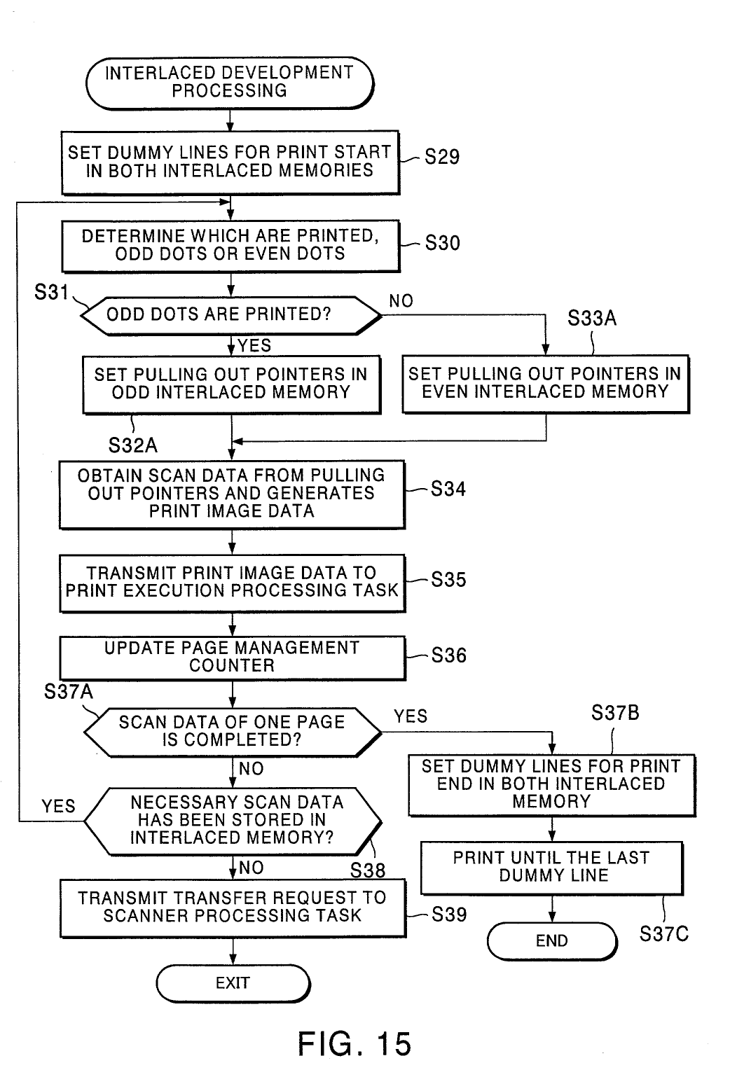

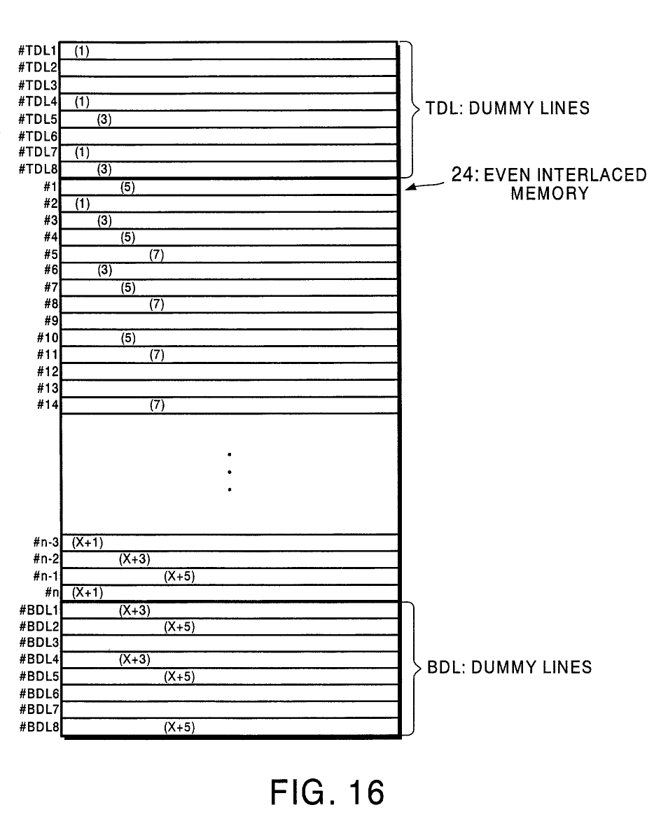

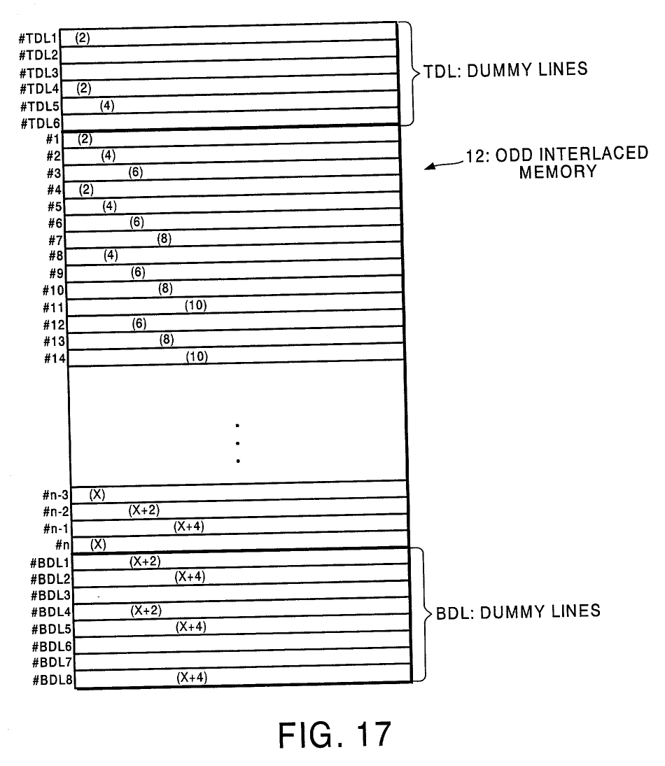

FIG. 15 is a flow chart for explaining processing contents of the interlaced processing task 42 according to this embodiment. With reference to FIG. 15, first, dummy lines TDL for a print start are formed at the top of the even interlaced memory 24 and the odd interlaced memory 26 in this embodiment (Step S29). FIG. 16 is a diagram showing a construction of the even interlaced memory 24 and FIG. 17 is a diagram showing a construction of the odd interlaced memory 26. However, the amount of capacities for one page is not reserved in the printer RAM 18 as the even interlaced memory 24 and the odd interlaced memory 26 at a time, but the amount of capacities for the number of predetermined lines is reserved in the printer RAM 18 and it is cyclically used while the scan data corresponding a line which has already been printed is discarded. Therefore, FIG. 16 and FIG. 17 are the concept explanation diagrams for an assistance to understand only.

With reference to FIG. 16, in the interlaced processing task 42 according to this embodiment, it adds the dummy lines TDL composed of lines #TDL1 through #TDL8 to the top of the even interlaced memory 24 before it starts printing the scan data. The reason why the dummy lines TDL are added is that it is impossible to correctly print in eight lines from its print start because of the effective print area mentioned above. Therefore, data instructing the ink jet nozzles not to spout the ink are prepared, namely, the dummy lines TDL in which NULL data are written are prepared.

Similarly, with reference to FIG. 17, in the interlaced processing task 42 according to this embodiment, it adds the dummy lines TDL composed of lines #TDL1 through #TDL6 to the top of the odd interlaced memory 26 before it starts printing the scan data. The reason why the dummy lines TDL are added is that it is impossible to correctly print in six lines from its print start because of the effective print area mentioned above. Therefore, data instructing the ink jet nozzles not to spout the ink are prepared, namely, the dummy lines TDL in which NULL data are written are prepared. However, it is once at a start of a copy print that the dummy lines TDL are set in the interlaced memories 24 and 26.

Next with reference to FIG. 15, the interlaced processing task 42 decides whether the odd dots will be printed in the next print pass or the even dots will be printed in the next print pass (Step 30). Subsequently, the interlaced processing task 42 judges whether it has been determined to print the odd bots in the next pass or not (Step S31). If it has been determined to print the even dots (Step S31: No), pulling out pointers are set in the even interlaced memory 24 (Step S33A).

The manner of setting the pulling out pointers is different from the first and second embodiments described above. That is, as shown in FIG. 16, the pulling out pointers are set every three lines from the top of the even interlaced memory 24. In other words, the pulling out pointers are set every three lines from the dummy line #TDL1. However, when the next pulling out pointers are set, they are shifted from the last set pulling out pointers by four lines in the sub-scan pass direction.

On the other hand, it has been judged to print the odd dots in Step S31 (Step S31: Yes), the pulling out pointers are set in the odd interlaced memory 26 (Step S32A).

The manner of setting the pulling out pointers is the same as that of even interlaced memory 24 described above. That is, as shown in FIG. 17, the pulling out pointers are set every three lines from the top of the odd interlaced memory 26. In other words, the pulling out pointers are set every three lines from the dummy line #TDL1. However, when the next pulling out pointers are set, they are shifted from the last set pulling out pointers by four lines in the sub-scan pass direction.

Next, as shown in FIG. 15, the interlaced processing task 42 obtains the scan data at the pulling out pointers and then generates the print image data (Step S34). Then, the interlaced processing task 42 transmits the generated print image data to the print execution processing task 40 (Step S35). As a result, the printing operation in which the print head moves once in the main scan direction is performed.

Next, a page management counter is updated (Step S36). This page management counter is a counter to judge whether the print image data of one page has been generated or not.

Subsequently, the interlaced processing task 42 judges whether or not the receiving processing of the scan data of one page is completed based on the page management counter (Step S37A). If the receiving processing of the scan data of one page is completed (Step S37A: Yes), dummy lines BDL for print end are set in the even interlaced memory 24 and the odd interlaced memory 26 (Step S37B).

In the example of FIG. 16, before the print operation for the scan data is ended, the dummy lines BDL composed of line #BDL1 through line #BDL8 are added to the bottom of the even interlaced memory 24. The reason why the dummy lines BDL are added is that it is impossible to correctly print in eight lines before its print end because of the effective print area mentioned above. Therefore, data instructing the ink jet nozzles not to spout the ink are prepared, namely, the dummy lines BDL in which NULL data are written are prepared.

Similarly, with reference to FIG. 17, before the print operation for the scan data is ended, the dummy lines BDL composed of line #BDL1 through line BDL#8 are added to the bottom of the odd interlaced memory 26. The reason why the dummy lines BDL are added is that it is impossible to correctly print in eight lines before its print end because of the effective print area mentioned above. Therefore, data instructing the ink jet nozzles not to spout the ink are prepared, namely, the dummy lines BDL in which NULL data are written are prepared.

Next, as shown in FIG. 15, the interlaced processing task 42 performs the print operation until the bottom of the dummy lines BDL (Step S37C). That is, for the even interlaced memory 24 shown in FIG. 16, while the pulling out pointers are set every three lines and four lines are shifted every one print pass end, the print operation is performed until the dummy line #BDL8. As a result, it is possible to obtain a correct print result until the last line #n of the scan data.

Furthermore, for the odd interlaced memory 26 shown in FIG. 17, while the pulling out pointers are set every three lines and four lines are shifted every one print pass end, the print operation is performed until the dummy line #BDL8. As a result, it is possible to obtain a correct print result until the last line #n of the scan data. As a result, the interlaced processing task 42 is completed.

On the other hand, as shown in FIG. 15, if the scan data of one page is not completed (Step S37A: No), it judges whether or not the scan data necessary to execute the next interlaced processing is stored in the interlaced memory 18a (Step S38).

If it has judged that the scan data necessary to execute the next interlaced processing is stored in the interlaced memory 18a (Step S38, Yes), the processes from the step S30 are repeated.

On the other hand, if it has judged that the scan data necessary to executes the next interlaced processing is not stored in the interlaced memory 18a (Step S38: No), the next transfer request is transmitted to the scanner processing task 41 (Step S39). Then, the interlaced processing task 42 is stopped for the present. In this case, by transmitting the transfer end message from the scanner processing task 41 mentioned above, this interlaced processing task 41 is activated again.

As described above, according to multi-function printer 5 of also this embodiment, in the same manner as the above-mentioned first and second embodiments, since the scan data has been divided into the even bits and the odds bits and they have been stored in the even interlaced memory 24 and the odd interlaced memory 26 respectively, it is unnecessary to classify the scan data into the even bits and the odd bits in the interlaced processing task 42. Therefore, even though it is a high definition printing operation, it is possible to execute the printing operation by the maximum throughput of the printer engine 22. That is, it is possible that the main scan pass operation of the carriage mounted with the print head of the printer does not stop to print the scan data which is read in by the scanner mechanism section 10.

Furthermore, in this embodiment as well, the processing in which the scan data is classified into the even data and the odd data is executed in the scanner ASIC 12, i.e. a hardware, so that the classificational processing can be performed at high speed even though the multi-function printer 5 has only one CPU 16. The printing time shorter than before can be realized even though the processing speed of the CPU 16 is not enough.

This invention is not limited to the embodiments explained above, but various modifications are possible. For example, in the above-mentioned embodiments, the print image data of one dot is generated from the data of one bit, but the invention is not limited to this. That is, the print image data of one dot may be generated from multi-valued data of 2 bits (00, 01, 10 and 11, for example) and so on. In this case, there are four patterns, which are a large dot, a medium dot, a small dot and no dot, for one dot.

Moreover, the case where one line of the scan data is printed by two print passes is explained in the embodiments mentioned above, but this invention can be applied to cases where one line of the scan data is printed by three, four, . . . print passes. In these cases, the interlaced memory 18a is divided into three, four, . . . in compliance with each case, and then the scanner ASIC 12 classifies the scan data in compliance with the divided interlaced memory 18a.

Further, the multi-function printer 5 performs the interlaced processing that other lines are printed again between the lines printed on the printing pager in the embodiments mentioned above, but this interlaced processing is not always necessary in the present invention. That is, the invention can be applied to a printer which does not perform the interlaced processing, too.

Moreover, the classificational processing for the scan data is executed in the scanner ASIC 12 in the embodiments mentioned above, but it may be executed in other hardware mechanism or a software mechanism.

Furthermore, a manner of the high definition printing operation is not limited to the embodiments explained above. The present invention can be applied to a printer in which a resolution of the ink jet nozzles in the print head is coarser than that on the printing paper and the print on the printing paper is completed by a plurality of print passes.

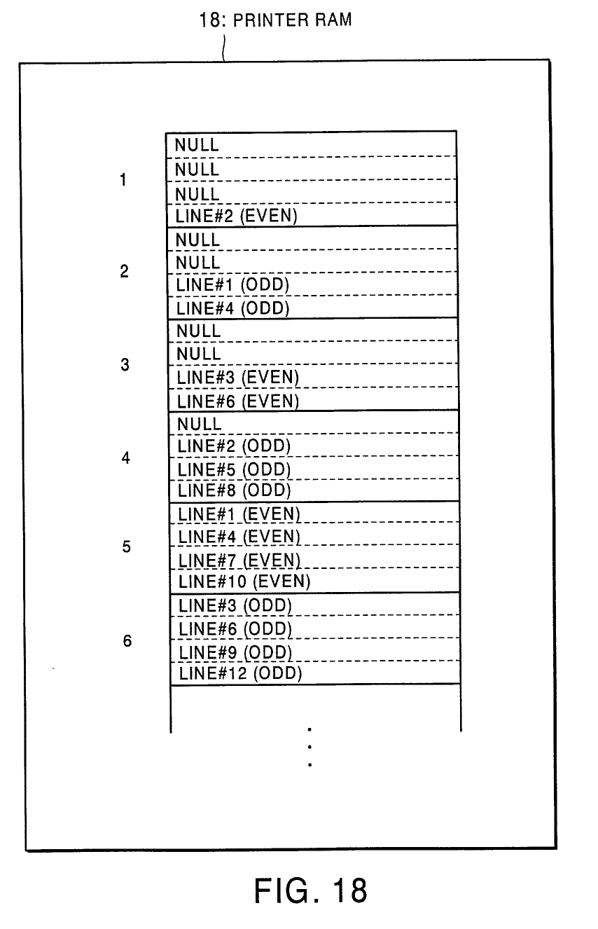

In addition, the processing for generating the print data, which can be printed in the printer engine, on the basis of the scan data is a bit classificational processing for the high definition print in the embodiments mentioned above, but the present invention can be applied to a case where the print data which can be printed in the printer engine is generated through other processing for the scan data. For example, in the third embodiment, as shown in FIG. 18, the scanner ASIC 12 may perform the interlaced processing for extracting data from the scan data every three lines, classifies the data into even bits and odd bits, and stores the data in the printer RAM 18. If the scanner ASIC 12 performs these processing, the scan data is stored in the printer RAM 18 in order of the print pass. As a result, in the CPU 16 in the printing operation, the interlaced processing is also unnecessary, and then the CPU 16 needs only to extract the scan data four lines by four lines from the top of the printer RAM 18 to execute the print operation.

Moreover, in another example for the first through third embodiments mentioned above, the present invention can be applied to a multi-function printer which does not perform the processing for extracting the even bits and odd bits but which does perform the interlaced processing only. In this case, in the third example for instance, it is adoptable that the scan data is subjected to the interlaced processing for extracting data from the scan data every three lines and then it is stored in the printer RAM 18. In this way, the multi-function printer needs only to extract the scan data from the top of the printer RAM 18 four lines by four lines in order during its print operation. In addition, the classificational processing for extracting data from the scan data every three lines may be executed in the scanner ASIC 12 or the CPU 16 in this case.

Furthermore, the print operation for the even bits is previous to that for odd bits in the same line in the embodiments mentioned above, but it may be in reverse order so that the print operation for the odd bits may be previous to that for the even dots.

In addition, in the embodiments mentioned above, a case where a print medium is the print paper is explained as an example, but other print medium such as an OHP sheet and the like may be used.

Concerning the task processing such as the print execution processing task 40, the scanner processing task 41 and the interlaced processing task 42 or the like explained in the foregoing embodiments, the programs for executing these processing can be stored on and distributed in the form of a recording medium, for example, a floppy disk, a CD-ROM (compact disc read only memory), a ROM, a memory card, etc. In this case, once the multi-function printer 5 reads such programs from the recording medium and executes the programs, the embodiment explained above can be realized.

In many cases, the multi-function printer 5 has other programs such as an operating system, other application programs, and so on. In these cases, in order to efficiently use the other programs of the multi-function printer 5, instructions may be recorded on the recording medium for calling, from the other programs of the multi-function printer 5, one or more programs that can realize processing equivalent to the processing of the foregoing embodiments.

Moreover, these programs may also be distributed as a carrier wave through a network, instead of the recording medium. The programs, transmitted as the carrier wave through the network, can be stored in the multi-function printer 5 and executed to realize the foregoing embodiments.

In some cases, the programs are encrypted and/or compressed when they are recorded on the recording medium or transmitted as the carrier wave through the network. In these cases, having acquired the programs from the recording medium or the carrier wave, the multi-function printer 5 has to decrypt and/or expand the programs before executing them.

What is claimed is:

1. A multi-function printer which is a combination of a scanner and a printer, comprising:
a first data storage in which a scan data scanned in by the scanner is stored;
a print executer which generates a print image data having a data format suitable for a print processing on the basis of the scan data stored in the first data storage and performs printing by a print pass driving a print head of the printer with the print head moved on the basis of the print image data; and
a data classifier which classifies the scan data in a format suitable for generating the print image data and stores it in the first data storage.

2. The multi-function printer as set forth in claim 1, wherein a resolution of the printer head is coarser than a resolution to be printed on a print medium by the printer, and the printer performs printing by a plurality of print passes for one line of the scan data.

3. The multi-function printer as set forth in claim 2, wherein the data classifier classifies the scan data into compliance with the print passes.

4. The multi-function printer as set forth in claim 2, wherein the print passes for one line of the scan data are twice, and the data classifier classifies the scan data into even bits thereof and odd bits thereof and stores them in the first data storage.

5. The multi-function printer as set forth in claim 1, wherein the data classifier comprising:
a second data storage in which the scan data scanned in by the scanner is temporarily stored; and
a classificational executer which read out the scan data from the second data storage, classifies it and stores it in the first data storage.

6. The multi-function printer as set forth in claim 5, wherein the classificational executer classifies the scan data into even bits and odd bits, and stores data of the even bits of the scan data in an even bit data storage in the first data storage every line of the scan data and stores data of the odd bits of the scan data in an odd bit data storage in the first data storage every line of the scan data,
wherein the print executer executes an interlaced processing that the scan data is extracted from the even bit data storage and the odd bit data storage every other line respectively, and executes the printing.

7. The multi-function printer as set forth in claim 6, wherein the classificational executer has a latch buffer of a predetermined data length, and latches the scan data of the predetermined data length into the latch buffer and obtains the scan data to be stored in the even bit data from even bits of the latch buffer and the scan data to be stored in the odd bit data from odd bits of the latch buffer.

8. The multi-function printer as set forth in claim 6, wherein the classificational executer comprising:
an even look up table in which even bit data obtainable by extracting even bits from the scan data of the predetermined data length are stored for all patterns of the scan data of the predetermined data length; and
an odd look up table in which odd bit data obtainable by extracting odd bits from the scan data of the predetermined data length are stored for all patterns of the scan data of the predetermined data length,
wherein the classificational executer reads out the scan data from the second data storage by the predetermined data length for every time and compares the read-out scan data with the even look up table so that the scan data to be stored in the even bit data storage is obtained, and compares the read-out scan data with the odd look up table so that the scan data to be stored in the odd bit data storage is obtained.

9. The multi-function printer as set forth in claim 6, wherein the print executer alternately repeats:
a processing for reading out the scan data from one of the even bit data storage and the odd bit data storage every K lines, performing one print pass and feeding the print medium by F lines, and;
a processing for reading out the scan data from the other of the even bit data storage and the odd bit data storage every K lines, performing one print pass and feeding the print medium by F lines,
wherein relationship between the K and the F is prime to each other.

10. The multi-function printer as set forth in claim 6, wherein the classificational executer is constituted of hardware.

11. The multi-function printer as set forth in claim 10, wherein the interlaced processing executed in the print executer is performed as a software processing.

12. The multi-function printer as set forth in claim 11, wherein the software processing is executed in a central processing unit, which is shared between the scanner and the printer and which is the only one in the multi-function printer.

13. The multi-function printer as set forth in claim 5, wherein the first data storage and the second data storage are provided in different memories.

14. A multi-function printer which is a combination of a scanner and a printer and capable of printing one line of a scan data, which is scanned in by the scanner, in the printer by movements of a print head in a main scan pass direction by X times, comprising:
a classificational storing section which classifies the scan data according to an appropriate data format for each time of the X times of the movement of the print head in the main scan pass direction and which stores them in a first data storage;
a print image data generator which sequentially reads out the classified scan data from the first data storage and generates a print image data on the basis of the read-out scan data every reading out; and
a print executer which executes printing with the print head moved in the main scan pass direction on the basis of the print image data generated by the print image data generator.

15. The multi-function printer as set forth in claim 14, wherein the classificational storing section is constituted of hardware.

16. The multi-function printer as set forth in claim 15, wherein the print image data generator is implemented via a software processing, and the multi-function printer has only one central processing unit, which executes the software processing and which is shared between the scanner and the printer.

17. The multi-function printer as set forth in claim 14, wherein the print image data generator also executes an interlaced processing that data is extracted from the scan data stored in the first data storage every predetermined lines.

18. The multi-function printer as set forth in claim 14, further comprising a second data storage in which the scan data scanned in by the scanner is temporarily stored,
wherein the classificational storing section sequentially reads out the scan data from the second data storage and classifies them.

19. A control method for a multi-function printer, which is a combination of a scanner and a printer, comprising the steps of:
classifying a scan data scanned in by the scanner according to an appreciate format for generating a print image data in actual printing;
storing the classified scan data in a first data storage under classified conditions;
generating the print image data, which has a data format appropriate for a print processing, on the basis of the scan data stored in the first data storage; and
performing the print processing by a print pass with a print head of the printer moved on the basis of the print image data.

20. A control method for a multi-function printer which is a combination of a scanner and a printer and capable of printing one line of a scan data, which is scanned by the scanner, in the printer by movements of a print head in a main scan pass direction by X times, comprising the steps of:
classifying the scan data according to an appropriate data format for each of the X times of the movement of the print head in the main scan pass direction;
storing the classified scan data in a first data storage;
reading out the classified scan data sequentially from the first data storage to generates a print image data on the basis of the scan data every reading out; and
executing printing with the print head moved in the main scan pass direction on the basis of the generated print image data.
